(19) United States
(12) Patent Application Publication
(10) Pub. No.: US 2011/0228169 A1
(43) Pub. Date: Sep. 22, 2011

(54) VIDEO PROCESSING APPARATUS AND VIDEO DISPLAY APPARATUS

(76) Inventors: Shinya Kiuchi, Osaka (JP); Mitsuhiro Mori, Osaka (JP)

(21) Appl. No.: 13/130,401

(22) PCT Filed: Dec. 17, 2009
(86) PCT No.: PCT/JP2009/006984

§ 371 Date: May 20, 2011

(30) Foreign Application Priority Data
Dec. 24, 2008 (JP) 2008-327760

(51) Int. Cl. H04N 5/14

(52) U.S. Cl. 348/699; 348/E05.066

(57) ABSTRACT

A video processing apparatus includes: a subfield conversion portion (2) which converts an input image into light emission data for each of subfields; a motion vector detection portion (3) which detects a motion vector using at least two or more input images before and after in time; a subfield regeneration portion (4) which generates rearranged light emission data for each of the subfields by spatially rearranging the light emission data for each of the subfields according to the motion vector; and a subfield correction portion (5) which corrects the rearranged light emission data such that light is emitted in at least one non-emission subfield temporally in advance of at least one emission subfield for which an immediately preceding non-emission period is longest.

### TECHNICAL FIELD

This invention relates to a video processing apparatus which performs processing of an input image to divide one field or one frame into a plurality of subfields, and combine an emission subfield in which light is emitted and a non-emission subfield in which light is not emitted to perform gradation display, and to a video display apparatus using this apparatus.

### BACKGROUND ART

A plasma display apparatus has the advantages of being flat and enabling large-screen display; AC-type plasma display panels used in such plasma display apparatuses combine a front plate comprising a glass substrate on which are arranged and formed a plurality of scanning electrodes and sustain electrodes, and a rear plate on which are arranged a plurality of data electrodes, such that the scanning electrodes and sustain electrodes perpendicularly intersect the data electrodes to form discharge cells in a matrix shape; video is displayed by selecting arbitrary discharge cells and causing plasma light emission.

When displaying video as described above, one field or one frame is divided in the time direction into a plurality of screens with different brightness weightings (hereafter these are called subfields (SFs)), and by controlling light emission or light non-emission of discharge cells in each subfield, the image of one field, that is, one frame image, is displayed.

In a video display apparatus using the above subfield division, when displaying moving images there are the problems that gradation disturbances, called dynamic false contours, and motion blur occur, detracting from display quality. In order to reduce the occurrence of such dynamic false contours, for example Patent Document 1 discloses a video display apparatus in which motion vectors are detected taking the pixels of one field as a starting point and the pixels of another field as an ending point among the plurality of fields included in moving images, moving images are converted into light emission data for subfields, and subfield light emission data is reconstructed by processing using motion vectors.

In a video display apparatus of the prior art, by selecting among motion vectors a motion vector which has pixels for reconstruction of another field as an ending point, multiplying this by a prescribed function to calculate a position vector, and using the light emission data for the subfield of the pixel indicated by the position vector to reconstruct light emission data for the subfield of the pixels for reconstruction, the occurrence of motion blur and dynamic false contours is suppressed.

As above, in a video display apparatus of the prior art, moving images are converted into light emission data for each subfield, and light emission data for each subfield is rearranged according to motion vectors; the method of rearrangement of light emission data for each subfield is explained in detail below.

FIG. 8 is a schematic diagram showing one example of a transition state of a display screen; FIG. 9 is a schematic diagram used to explain light emission data for each subfield before rearrangement of light emission data for each subfield when displaying the display screen shown in FIG. 8; and FIG. 10 is a schematic diagram used to explain light emission data for each subfield after rearrangement of light emission data for each subfield when displaying the display screen shown in FIG. 8.

As shown in FIG. 8, as continuous frame images, for example an N−2nd frame image D1, N−1st frame image D2, and Nth frame image D3 are displayed in order, and as background, an all-black pixel (for example, brightness level 0) state is displayed; in addition, as the foreground, an example of a white circle (for example, brightness level 255) moving object OJ, moving from left to right on the display screen, is considered.

First, the above image display apparatus of the prior art converts a moving image into light emission data for each subfield, and as shown in FIG. 9, light emission data for each subfield of each pixel for each frame is created as follows.

Here, when displaying from the N−2nd frame image D1 to the Nth frame image D3, supposing that one field is formed from five subfields SF1 to SF5, first in the N−2nd frame, the light emission data for all of the subfields SF1 to SF5 of the pixel P-10 corresponding to the moving object OJ is the light-emitting state (subfields indicated by shading in the figure), and the light emission data for the subfields SF1 to SF5 of the other pixels is the light non-emitting state (not shown). Next, in the N−1st frame, when the moving object OJ has moved horizontally five pixels, the light emission data for all of the subfields SF1 to SF5 of the pixel P-5 corresponding to the moving object OJ is the light emitting state, and the light emission data for the subfields SF1 to SF5 of the other pixels is the light non-emitting state. Next, in the Nth frame, when the moving object OJ has moved horizontally five pixels, the light emission data for all of the subfields SF1 to SF5 of the pixel P-0 corresponding to the moving object OJ is the light emitting state, and the light emission data for the subfields SF1 to SF5 of the other pixels is the light non-emitting state.

Next, the above image display apparatus of the prior art rearranges light emission data for each subfield according to the motion vector, and as shown in FIG. 10, creates light emission data after rearrangement of subfields for each pixel in each frame, as follows.

First, as the motion vector V1 from the N−2nd frame and the N−1st frame, when a movement amount of five pixels in the horizontal direction is detected, in the N−1st frame the light emission data for the first subfield SF1 of the pixel P-5 (light-emitting state) moves to the left by four pixels, the light emission data for the first subfield SF1 of the pixel P-9 is changed from the light non-emitting state to the light-emitting state (subfields indicated by shading in the figure), and the light emission data for the first subfield SF1 of the pixel P-5 is changed from the light-emitting state to the light non-emitting state (subfields indicated by dashed lines enclosing white areas).

Further, the light emission data for the second subfield SF2 of pixel P-5 (light-emitting state) is moved three pixels in the left direction, and the light emission data for the second subfield SF2 of pixel P-8 is changed from the light non-emitting state to the light-emitting state, while the light emission data for the second subfield SF2 of pixel P-5 is changed from the light-emitting state to the light non-emitting state.

Further, the light emission data for the third subfield SF3 of pixel P-5 (light-emitting state) is moved two pixels in the left direction, and the light emission data for the third subfield SF3 of pixel P-7 is changed from the light non-emitting state to the light-emitting state, while the light emission data for the third subfield SF3 of pixel P-5 is changed from the light-emitting state to the light non-emitting state.

Further, the light emission data for the fourth subfield SF4 of pixel P-5 (light-emitting state) is moved one pixel in the left direction, and the light emission data for the fourth subfield SF4 of pixel P-6 is changed from the light non-emitting state to the light-emitting state, while the light emission data for the fourth subfield SF4 of pixel P-5 is changed from the light-emitting state to the light non-emitting state. Further, the light emission data for the fifth subfield SF5 of pixel P-5 is not changed.

Similarly, as the motion vector V2 from the N−1st frame and Nth frame, when a movement amount of five pixels in a horizontal direction is detected, the light emission data for the first to fourth subfields SF1 to SF4 of pixel P-0 (light-emitting state) is moved from four to one pixels in the left direction, the light emission data for the first subfield SF1 of pixel P-4 is chanced from the light non-emitting state to the light-emitting state, the light emission data for the second subfield SF2 of pixel P-3 is changed from the light non-emitting state to the light-emitting state, the light emission data for the third subfield SF3 of pixel P-2 is changed from the light non-emitting state to the light-emitting state, the light emission data for the fourth subfield SF4 of pixel P-1 is changed from the light non-emitting state to the light-emitting state, the light emission data for the first to fourth subfields SF1 to SF4 of pixel P-0 is changed from the light-emitting state to the light non-emitting state, and the light emission data for the fifth subfield SF5 is not changed.

Through the above subfield rearrangement processing, when a viewer sees the transition from the N−2nd frame to the Nth frame, the direction of the line of sight moves smoothly along the direction of arrow AR, and the occurrence of motion blur and dynamic false contours can be suppressed.

However, in the above subfield rearrangement processing of the prior art, only one subfield is selected from among the plurality of subfields of each pixel, and plasma light emission is performed for only the one selected subfield. In the plasma display panel, prior to performing write discharge, driving is performed such that wall charge is accumulated on the partition walls, the phosphor and the dielectric forming the discharge cells and write discharge occurs by means of a potential difference resulting from adding the potential difference applied from outside to the potential difference due to this wall charge; when a long time (several tens of microseconds or more) elapses from formation of this wall charge, the wall charge gradually decreases, and write discharge no longer occurs readily. In this way, whether plasma light emission occurs depends on the immediately preceding light-emitting state; the longer the immediately preceding light non-emitting state, the less readily light emission occurs.

FIG. 11 is a schematic diagram showing an example of brightness distribution among subfields of an NTSC video, and FIG. 12 is a schematic diagram used to explain that, when the seventh subfield is made to emit light among the first to seventh subfields, the light emission probability changes according to the immediately preceding light-emitting state. In FIG. 12, shaded subfields are emission subfields, and white subfields are non-emission subfields.

As shown in FIG. 11, in the case of NTSC video at frequency 60 Hz, for example one field is divided into first to seventh subfields SF1 to SF7, and subfields are set such that the larger the number of the subfield, the longer is the light emission period (the greater the number of plasma light emissions). In this case, the brightness of subfields increases with increasing subfield number, and the brightness distribution formed by light emission in all of the first to seventh subfields SF1 to SF7 forms a single peak shape; such a driving method is called a single-peak driving method. When using this single-peak driving method, the light emission probability when the light emission is attempted in the seventh subfield SF7, which is temporally last, is as shown in FIG. 12, and the longer the immediately preceding light non-emitting period, the more difficult light emission becomes.

Hence when the above subfield rearrangement processing of the prior art is used, the first to sixth subfields SF1 to SF6 preceding the seventh subfield SF7 which is temporally last tend to enter the light non-emitting state, and so light emission cannot be reliably caused in the seventh subfield SF7. Further, because the light emission time is longest in the seventh subfield SF7, if light emission no longer occurs in a seventh subfield SF7 in which light emission is to occur, the occurrence of motion blur and dynamic false contours cannot be suppressed; instead, video motion and dynamic false contours are emphasized, and image quality is degraded.
Patent Document 1: Japanese Patent Laid-open No. 2008-209671

### DISCLOSURE OF THE INVENTION

An object of this invention is to provide a video processing apparatus and video display apparatus, which is capable of more reliable light emission in subfields in which light is to be emitted, and which can more reliably suppress motion blur and dynamic false contours.

The video processing apparatus according to one aspect of the invention processes an input image so as to divide one field or one frame into a plurality of subfields and combine an emission subfield in which light is emitted and a non-emission subfield in which light is not emitted in order to perform gradation display, and includes a subfield conversion portion which converts the input image into light emission data for each of the subfields; a motion vector detection portion which detects a motion vector using at least two or more input images before and after in time; a regeneration portion which generates rearranged light emission data for each of the subfields by spatially rearranging the light emission data for each of the subfields converted by the subfield conversion portion according to the motion vector detected by the motion vector detection portion; and a correction portion which corrects the rearranged light emission data generated by the regeneration portion such that, among the plurality of subfields, light is emitted in at least one non-emission subfield temporally in advance of at least one emission subfield for which an immediately preceding non-emission period is longest.

By means of this invention, light emission can be caused more reliably in subfields in which light is to be emitted, and motion blur and dynamic false contours can be more reliably suppressed.

### BRIEF DESCRIPTION OF THE DRAWINGS

FIG. 1 is a block diagram showing the configuration of the video display apparatus of one embodiment of the invention;

FIG. 2 is a schematic diagram showing one example of moving image data;

FIG. 3 is a schematic diagram showing one example of subfield light emission data for the moving image data of FIG. 2;

FIG. 4 is a schematic diagram showing one example of rearranged light emission data obtained by rearrangement of the subfield light emission data of FIG. 3;

FIG. 5 is a schematic diagram showing one example of light emission data after correction of the subfield rearranged light emission data of FIG. 4;

FIG. 6 is a schematic diagram showing one example of the brightness distribution of subfields of PAL video;

FIG. 7 is a schematic diagram showing one example of light emission data after correction of the subfield rearranged light emission data in the two-peak driving method shown in FIG. 6;

FIG. 8 is a schematic diagram showing one example of display screen transition states;

FIG. 9 is a schematic diagram used to explain light emission data for subfields before rearrangement of light emission data for subfields when displaying the display screens shown in FIG. 8;

FIG. 10 is a schematic diagram used to explain light emission data for subfields after rearrangement of light emission data for subfields when displaying the display screens shown in FIG. 8;

FIG. 11 is a schematic diagram showing one example of the brightness distribution of subfields of NTSC video;

FIG. 12 is a schematic diagram used to explain changes in the light emission probability according to the immediately preceding light-emitting state, when light emission is attempted in the seventh subfield among the first to seventh subfields; and

FIG. 13 is a schematic diagram showing one example of the state in which light emission is caused in the first subfield only for pixels with a low light emission probability.

### BEST MODE FOR CARRYING OUT THE INVENTION

Below, video display apparatuses of the invention are explained referring to the drawings. In the following embodiments, examples of plasma display apparatuses are explained as examples of video display apparatuses; but video display apparatuses to which this invention is applied are not limited to such examples in particular, and the invention can be similarly applied to other video display apparatuses in which one field or one frame is divided into a plurality of subfields and hierarchical display is performed.

Further, in this Description, “subfield” includes the meaning “subfield period”, and “subfield light emission” includes the meaning “pixel light emission in a subfield period”. Further, the light emission period of a subfield means the sustained period of light emission by sustained discharge so as to enable perception by a viewer, and does not include an initial period, write period and similar in which light emission which can be perceived by a viewer is not performed. A non-emission period immediately preceding a subfield means a period in which light emission enabling viewing by a viewer is not performed, and includes an initialization period and write period in which light emission which can be perceived by a viewer is not performed, as well as a sustain period in which sustain discharge is not performed, and similar.

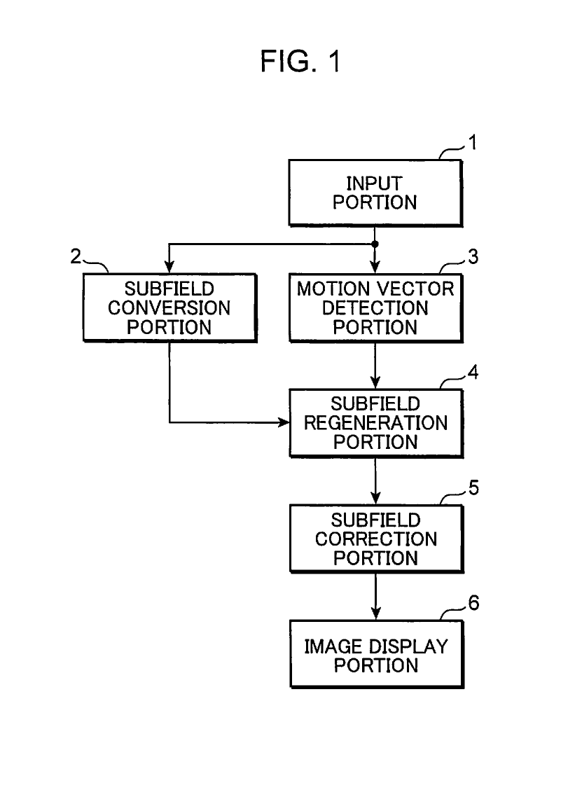

FIG. 1 is a block diagram showing the configuration of the video display apparatus of one embodiment of the invention. The video display apparatus shown in FIG. 1 comprises an input portion 1, subfield conversion portion 2, motion vector detection portion 3, subfield regeneration portion 4, subfield correction portion 5, and image display portion 6. Further, a video processing apparatus is configured to perform processing of an input image such that, by means of the subfield conversion portion 2, motion vector detection portion 3, subfield regeneration portion 4, and subfield correction portion 5, one field or one frame is divided into a plurality of subfields, and emission subfields in which light is emitted and non-emission subfields in which light is not emitted are combined, to perform gradation display.

The input portion 1 comprises for example a tuner for TV broadcasts, image input terminal, network connection terminal, or similar; moving image data is input to the input portion 1. The input portion 1 performs publicly known conversion processing and similar of the input moving image data, and frame image data after conversion processing is output to the subfield conversion portion 2 and motion vector detection portion 3.

The subfield conversion portion 2 sequentially converts one frame of image data, that is, one field of image data, into light emission data for subfields, and outputs the result to the subfield regeneration portion 4.

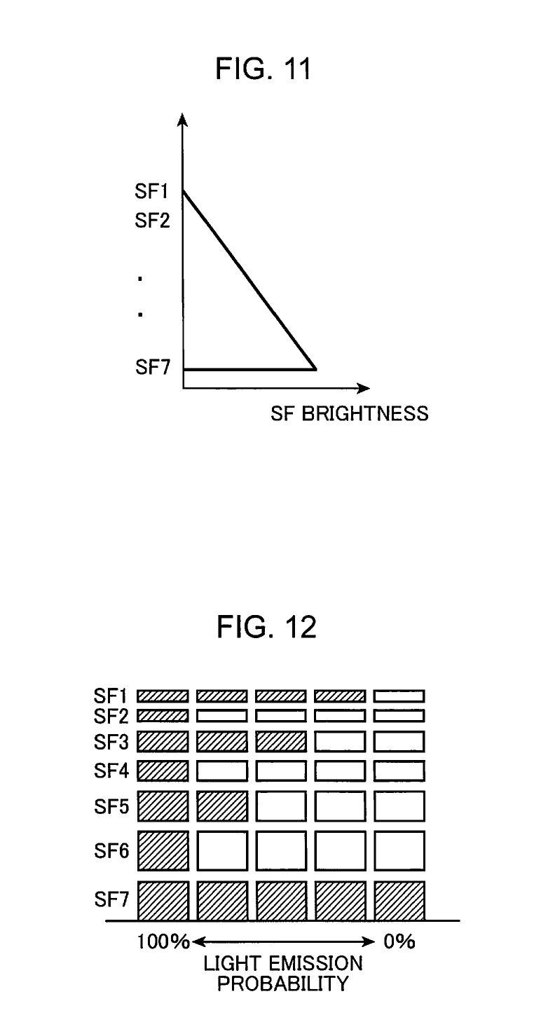

Here, a method of gradation expression of a video display apparatus which expresses gradations using subfields is explained. One field comprises K subfields (where K is an integer equal to or greater than 2), each subfield is assigned a prescribed weighting corresponding to brightness, and the light emission period is set such that the brightness of the subfields changes according to the weightings. For example, when seven subfields are used, and 2 to the 7th power weightings are assigned, the weightings of the first to seventh subfields are respectively 1, 2, 4, 8, 16, 32 and 64, and by combining light-emitting states and light non-emitting states for each subfield, video can be expressed with gradations in the range 0 to 127. In this case, single-peak driving in the NTSC format shown in FIG. 11 is used. The number of subfield divisions, weightings, arrangement order and the like are not limited to those of the above example in particular, and various modifications are possible.

The image data for two temporally consecutive frames, for example, the image data for frame N−1 and the image data for frame N (where N is an integer), is input to the motion vector detection portion 3, and the motion vector detection portion 3 detects motion vectors by pixel for the frame N by detecting the amount of motion between these frames, and outputs the result to the subfield regeneration portion 4. As this motion vector detection method, a publicly known motion vector detection method is used; for example, a detection method employing matching processing by blocks is employed.

The subfield regeneration portion 4 generates rearranged light emission data for each subfield by pixels in frame N by performing spatial rearrangement by pixels in frame N of the light emission data for each subfield converted by the subfield conversion portion 2, according to motion vectors detected by the motion vector detection portion 3, and outputs the result to the subfield correction portion 5.

For example, similarly to the rearrangement method shown in FIG. 10, the subfield regeneration portion 4 specifies the subfields in which light is emitted among the subfields for each pixel of frame N, changes to the light-emitting state the light emission data for subfields corresponding to pixels in positions moved spatially backward by the number of pixels corresponding to the motion vector, and changes to the light non-emitting state the light emission data for subfields of pixels prior to the displacement, so that the displacement is greater for subfields temporally in advance, according to the order of arrangement of subfields.

The subfield rearrangement method is not limited to that of this example in particular, and various modifications, such as rearrangement of subfield light emission data, can be made by collecting subfield light emission data for pixels positioned temporally forward by a number of pixels corresponding to motion vectors, as subfield light emission data for each pixel of the frame N, such that the displacement is greater for subfields temporally in advance, according to the order of subfield arrangement.

The subfield correction portion 5 corrects the rearranged light emission data and outputs the result to the image display portion 6 such that, among the plurality of subfields, at least one non-emission subfield temporally in advance of at least one emission subfield for which the immediately preceding non-emission period is longest is made to emit light.

For example, when one field is divided into first to seventh subfields SF1 to SF7, and light emission periods are set such that the larger the subfield number the longer the period, and moreover the temporal sequence of ignition is the order of subfield numbers, the subfield correction portion 5 specifies subfields for light emission among the second to seventh subfields SF2 to SF7 based on the rearranged light emission data, and corrects the rearranged light emission data such that the first subfield, which is in advance of the emission subfield and has the shortest light emission period, emits light.

The image display portion 6 comprises a plasma display panel, panel driving circuit and similar, and based on the corrected rearranged light emission data, controls the ignition and extinction of each subfield for each pixel of the plasma display panel to display moving images.

The subfield correction portion 5 may comprise a time measurement portion which measures the time of use of the video display apparatus. Here, as the time of use of a video display apparatus, the time elapsed after manufacture, the time over which a current is passed, the panel display time, or similar can be used.

In this case, until a certain time of use has elapsed, the subfield correction portion 5 outputs rearranged light emission data to the image display portion 6 without performing correction, and the image display portion 6 controls the ignition or extinction of each pixel based on the uncorrected rearranged light emission data to display moving images. On the other hand, upon detection by the time measurement portion that the certain time of use has elapsed, the subfield correction portion 5 corrects the rearranged light emission data and outputs the result to the image display portion 6, and the image display portion 6 controls ignition or extinction of each pixel based on the corrected rearranged light emission data as described above to display moving images.

Next, correction processing of rearranged light emission data by the video display apparatus configured as described above is explained in detail. First, moving image data is input to the input portion 1, and the input portion 1 performs prescribed conversion processing of the input moving image data, and outputs frame image data after conversion processing to the subfield conversion portion 2 and motion vector detection portion 3.

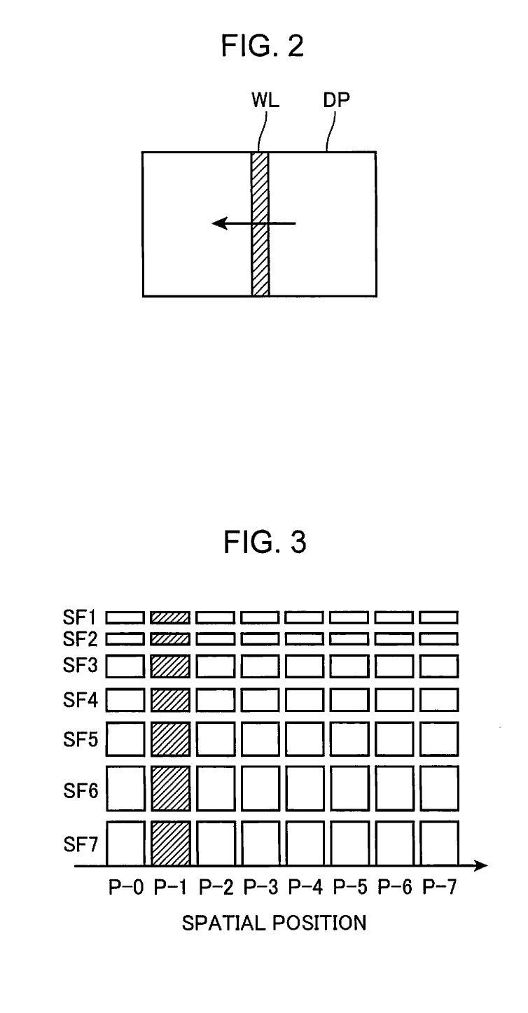

FIG. 2 is a schematic diagram showing one example of moving image data. The moving image data shown in FIG. 2 is a video in which, as the background, the entire screen of the display screen DP is displayed using black (the lowest brightness level), and as the foreground, a single white (maximum brightness level) line (line in which a column of single pixels is arranged in the vertical direction) WL moves from the right of the display screen DP to the left; for example, this moving image data is input to the input portion 1.

Next, the subfield conversion portion 2 converts in sequence the frame image data into light emission data for the first to seventh subfields SF1 to SF7 by pixel, and outputs the result to the subfield regeneration portion 4.

FIG. 3 is a schematic diagram showing an example of light emission data for subfields, for the moving image data shown in FIG. 2. For example, when the white line WL is positioned at pixel P-1 as the spatial position on the display screen DP (position in the horizontal direction x), the subfield conversion portion 2 generates light emission data which sets the first to seventh subfields SF1 to SF7 for the pixel P-1 to the light-emitting state (shaded subfields in the figure), and sets the first to seventh subfields SF1 to SF7 for the other pixels P-0 and P-2 to P-7 to the light non-emitting state (white subfields in the figure), as shown in FIG. 3. Hence when subfield rearrangement is not performed, the image is displayed on the display screen by the subfields as indicated in FIG. 3.

In parallel with creation of light emission data for the first to seventh subfields SF1 to SF7 above, the motion vector detection portion 3 detects the motion vector for each pixel between the data of two temporally consecutive frame images, and outputs the result to the subfield regeneration portion 4.

Next, the subfield regeneration portion 4 specifies subfields for light emission among the subfields for each pixel of the frame image to be displayed, and according to the order of arrangement of the first to seventh subfields SF1 to SF7, changes the light emission data for subfields corresponding to the pixel in the position moved spatially backward by the number of pixels corresponding to the motion vector to the light-emitting state, and changes the light emission data for the subfield of the pixel prior to the displacement to the light non-emitting state.

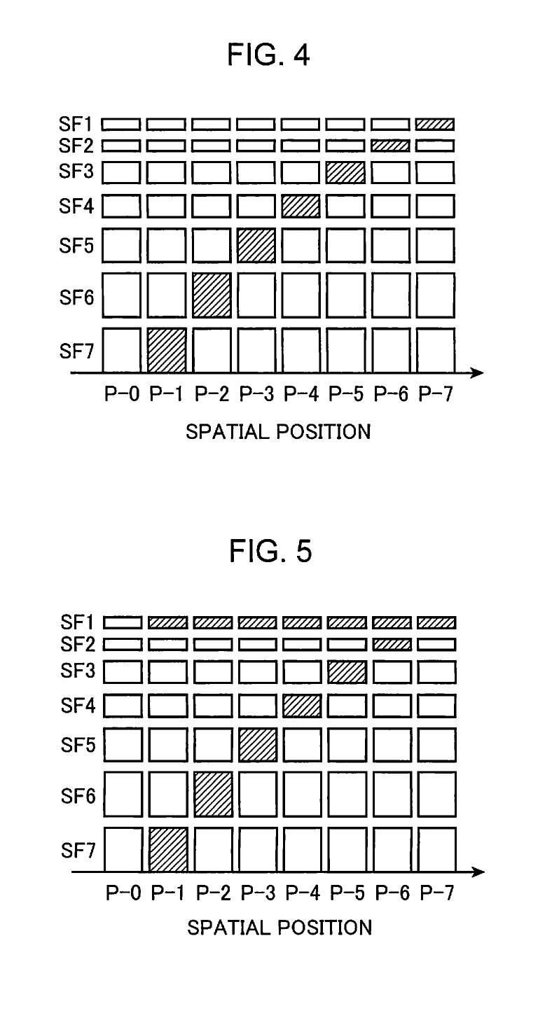

FIG. 4 is a schematic diagram showing an example of rearranged light emission data obtained by rearranging the subfield light emission data shown in FIG. 3. For example, when the pixel displacement corresponding to the motion vector is seven pixels, as shown in FIG. 4, the subfield regeneration portion 4 moves the light emission data for the first to sixth subfields SF1 to SF6 of the pixel P-1 (light-emitting state) by six to one pixels in the right direction, and by this means changes the light emission data for the first subfield SF1 of pixel P-7 from the light non-emitting state to the light-emitting state, changes the light emission data for the second subfield SF2 of pixel P-6 from the light non-emitting state to the light-emitting state, changes the light emission data for the third subfield SF3 of pixel P-5 from the light non-emitting state to the light-emitting state, changes the light emission data for the fourth subfield SF4 of pixel P-4 from the light non-emitting state to the light-emitting state, changes the light emission data for the fifth subfield SF5 of pixel P-3 from the light non-emitting state to the light-emitting state, changes the light emission data for the sixth subfield SF6 of pixel P-2 from the light non-emitting state to the light-emitting state, changes the light emission data for the first to sixth subfields SF1 to SF6 of pixel P-1 from the light-emitting state to the light non-emitting state, and does not change the light emission data for the seventh subfield SF7 of pixel P-1.

Hence when subfield rearrangement is performed, and the following correction is not performed, the image is displayed using the subfields of FIG. 4 on the display screen, but in this case, the longer the immediately preceding non-emission period, the less easily light emission is performed, and the probability that light is not emitted in the seventh subfield SF7 of pixel P-1 is highest.

Hence the subfield correction portion 5 detects subfields emitting light among the second to seventh subfields SF2 to SF7 of each pixel from the above rearranged light emission data, and corrects the rearranged light emission data such that the first subfield SF1 preceding this emission subfield emits light.

FIG. 5 is a schematic diagram showing one example of light emission data after correction of the subfield rearranged light emission data shown in FIG. 4. As shown in FIG. 5, from the subfield rearranged light emission data shown in FIG. 4, the subfield correction portion 5 detects that light is emitted in the seventh subfield SF7 of pixel P-1, the sixth subfield SF6 of pixel P-2, the fifth subfield SF5 of pixel P-3, the fourth subfield SF4 of pixel P-4, the third subfield SF3 of pixel P-5, and the second subfield SF6 of pixel P-6, and corrects the rearranged light emission data such that light is emitted in the first subfield SF1 of the pixels P-1 to P-6 which is in advance of these emission subfields.

Next, the image display portion 6 controls ignition or extinction of the subfields of each pixel based on the corrected rearranged light emission data to display moving images. As a result, light emission is caused not only the first subfield SF1 of pixel P-7, second subfield SF2 of pixel P-6, third subfield SF3 of pixel P-5, fourth subfield SF4 of pixel P-4, fifth subfield SF5 of pixel P-3, sixth subfield SF6 of pixel P-2, and seventh subfield SF7 of pixel P-1, but also in the first subfield SF1 of the pixels P-1 to P-6 which is temporally in advance of these subfields, so that light can be reliably emitted in all the subfields in which there is to be light emission, including the seventh subfield SF7 of pixel P-1, in which the probability that light will not be emitted is highest.

By means of the above processing in this embodiment, rearranged light emission data is corrected such that light is emitted in the first subfield SF1 of the pixels P-1 to P-6 temporally in advance of the emission subfields SF7 to SF2 of the pixels P-1 to P-6 having immediately preceding non-emission periods, so that after light is emitted in the first subfield SF1 of the pixels P-1 to P-6, light is emitted in the emission subfields SF7 to SF2 of pixels P-1 to P-6, and the non-emission periods between emission subfields can be shortened. As a result, light can be emitted more reliably in subfields in which light is to be emitted, and moreover motion blur and dynamic false contours can be suppressed more reliably.

Subfields for which the light emission data has been changed by correction so as to emit light are not particularly limited to the above-described first subfield; other subfields temporally in advance of emission subfields may be used, and emission subfields may be added so that two or more subfields emit light either consecutively or intermittently.

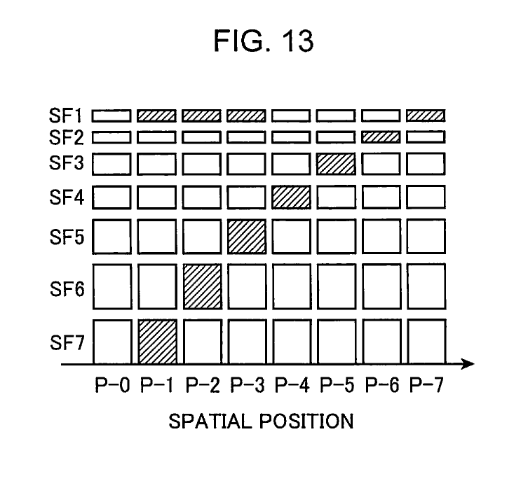

Further, all first subfields in advance of emission subfields which have immediately preceding non-emission periods were changed to emission subfields; but only subfields in advance of emission subfields for which the immediately preceding non-emission period is longest, or only subfields in advance of a prescribed number of subfields from the subfield with the longest immediately preceding non-emission period, may be changed to emission subfields, or, added emission subfields may be changed adaptively according to the probability of subfield light emission, or similar. FIG. 13 is a schematic diagram showing one example of a state in which light emission is caused in the first subfield only for pixels for which light emission probability is low. Particularly in the case of dark video signals, such as for example the second subfield SF2 and third subfield SF3 and similar with small subfield numbers in which light is emitted, the effect on brightness when light is emitted in the first subfield SF1 is large, and the probability of light emission is already high in the second subfield SF2 and third subfield SF3, so that light need not be emitted in the first subfield SF1.

Further, in the above explanation, subfields to be changed from non-emission subfields to emission subfields were decided based on the light-emitting states within one field; but the invention is not particularly limited to this example, and subfields to be changed from non-emission subfields to emission subfields may be decided according to light-emitting states of one or more previous fields.

Further, in the above explanation, an example was explained which used NTSC single-peak driving; but when the brightness distribution formed by all of the light emitted from a plurality of subfields forms two or more peaks, correction of rearranged light emission data may be performed such that the non-emission subfield with the shortest emission period for each peak emits light.

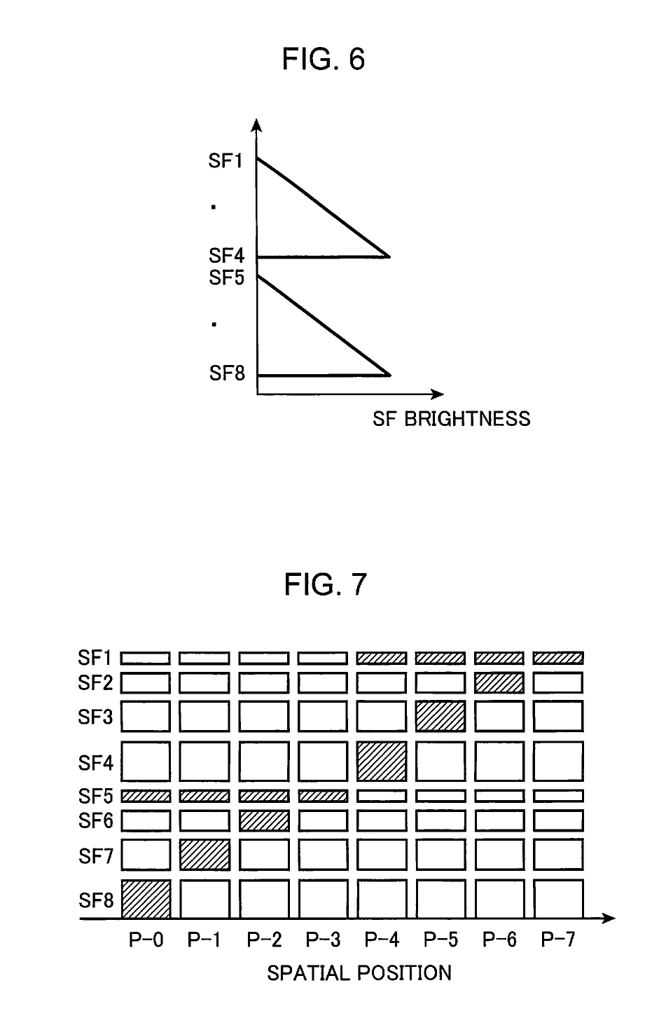

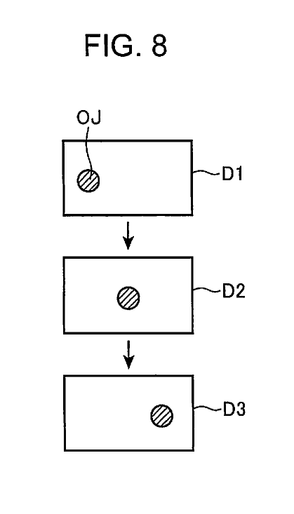

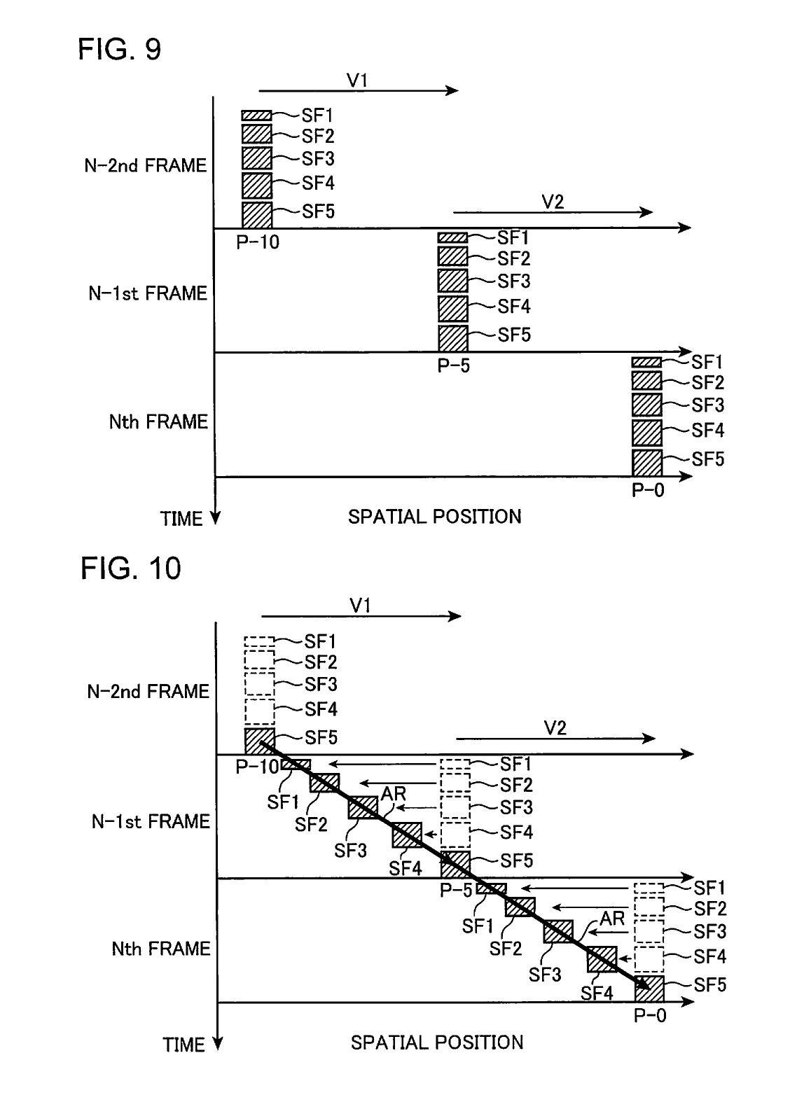

FIG. 6 is a schematic diagram showing one example of the brightness distribution for each subfield in PAL video. As shown in FIG. 6, in the case of PAL video at frequency 50 Hz, for example one field is divided into first to eighth subfields SF1 to SF8, the first to eighth subfields SF1 to SF8 are divided into two groups which are the first to fourth subfields SF1 to SF4 and the fifth to eighth subfields SF5 to SF8, and the subfields are set such that the larger the subfield number in each group, the longer is the light emission period (the greater the number of plasma light emissions). In this case, in each of the groups the brightness in each subfield is greater for larger subfield numbers, and the brightness distribution formed by all light emission in the first to fourth subfields SF1 to SF4 forms a single peak, while the brightness distribution formed by all light emission in the fifth to eighth subfields SF5 to SF8 forms a single peak, so that two peaks with the same shape are formed; such a driving method is called a two-peak driving method.

FIG. 7 is a schematic diagram showing one example of light emission data after correction of rearranged subfield light emission data in the two-peak driving method shown in FIG. 6. In the case of a two-peak driving method, when as shown in FIG. 7 the amount of pixel movement corresponding to motion vectors is for example eight pixels, the subfield regeneration portion 4, by moving the light emission data (light-emitting state) for the first to eighth subfields SF1 to SF8 of pixel P-0 in the right direction by seven to one pixels, changes the light emission data for the first subfield SF1 of pixel P-7 from the light non-emitting state to the light-emitting state; changes the light emission data for the second subfield SF2 of pixel P-6 from the light non-emitting state to the light-emitting state; changes the light emission data for the third subfield SF3 of pixel P-5 from the light non-emitting state to the light-emitting state; changes the light emission data for the fourth subfield SF4 of pixel P-4 from the light non-emitting state to the light-emitting state; changes the light emission data for the fifth subfield SF5 of pixel P-3 from the light non-emitting state to the light-emitting state; changes the light emission data for the sixth subfield SF6 of pixel P-2 from the light non-emitting state to the light-emitting state; changes the light emission data for the seventh subfield SF7 of pixel P-1 from the light non-emitting state to the light-emitting state; changes the light emission data for the first to seventh subfields SF1 to SF7 of pixel P-0 from the light-emitting state to the light non-emitting state; and does not change the light emission data for the eighth subfield SF8 of pixel P-0.

Next, from the above rearranged light emission data, the subfield correction portion 5 detects light emission in the eighth subfield SF8 of pixel P-0, the seventh subfield SF7 of pixel P-1, the sixth subfield SF6 of pixel P-2, the fifth subfield SF5 of pixel P-3, the fourth subfield SF4 of pixel P-4, the third subfield SF3 of pixel P-5, and the second subfield SF6 of pixel P-6, and corrects the rearranged light emission data such that, with respect to the first to fourth subfields SF1 to SF4, light is emitted in the first subfields SF1 of pixels P-4 to P-6, which are the non-emission subfields with shortest light emission periods in advance of these emission subfields, and such that, with respect to the fifth to eighth subfields SF5 to SF8, light is emitted in the fifth subfields SF5 of pixels P-0 to P-2, which are the non-emission subfields with shortest light emission periods in advance of these emission subfields.

As a result, in the two-peak driving method also, subfields are divided into peak units, and in each peak light is emitted in the fifth subfield SF5 of the pixels P-0 to P-2 (or the first subfield SF1 of the pixels P-4 to P-6) temporally in advance of the emission subfields SF8 to SF6 (or SF4 to SF2) of the pixels P-0 to P-2 (or P-4 to P-6) having immediately preceding non-emission periods, so that light can be emitted more reliably in all subfields in which light is to be emitted, and moreover motion blur and dynamic false contours can be suppressed more reliably.

Further, in the case of a two-peak driving method, rearrangement light emission data may be corrected such that light is emitted not only the fifth subfields SF5, but also in the first subfields SF1 or similar, in order that the emission probability of the fifth to eighth subfields SF5 to SF8 forming the succeeding peak is increased.

In the above, to facilitate the explanation, an example of pixel brightness was described; but when using pixels in each of the R, G and B colors to display full-color images, by applying the above processing to each color, clearly the above advantageous results can be obtained.

The invention can be summarized from the above embodiments as follows. That is, a video processing apparatus of this invention processes an input image so as to divide one field or one frame into a plurality of subfields, and combines an emission subfield in which light is emitted and a non-emission subfield in which light is not emitted in order to perform gradation display; and includes a subfield conversion portion which converts the input image into light emission data for each of the subfields; a motion vector detection portion which detects a motion vector using at least two or more input images before and after in time; a regeneration portion which generates rearranged light emission data for each of the subfields, by spatially rearranging the light emission data for each of the subfields converted by the subfield conversion portion according to the motion vector detected by the motion vector detection portion; and a correction portion which corrects the rearranged light emission data generated by the regeneration portion such that, among the plurality of subfields, light is emitted in at least one non-emission subfield temporally in advance of at least one emission subfield for which an immediately preceding non-emission period is longest.

In this video processing apparatus, input images are converted into light emission data for each subfield, and by spatially rearranging light emission data for each subfield according to motion vectors for input images, rearranged light emission data for each subfield is generated, and the rearranged light emission data is corrected such that light is emitted in at least one non-emission subfield temporally in advance of at least one emission subfield for which the immediately preceding non-emission period is longest, so that after light is emitted in the one non-emission subfield in advance of the emission subfield for which the immediately preceding non-emission period is longest, light is emitted in the emission subfield for which the immediately preceding non-emission period is longest, and the non-emission period between subfields in which light is emitted can be shortened. As a result, light can be emitted more reliably in subfields in which light is to be emitted, and moreover motion blur and dynamic false contours can be suppressed more reliably.

It is preferable that the correction portion perform correction of the rearranged light emission data generated by the regeneration portion such that, among the plurality of subfields, light is emitted in the non-emission subfield with a shortest emission period.

In this case, although light emission in the non-emission subfield with the shortest emission period is not originally necessary, because the emission period of this subfield is shortest, even when light is emitted in this subfield, emission in this subfield is not perceived by a viewer, and motion blur and dynamic false contours can be suppressed more reliably.

It is preferable that, when a brightness distribution formed by all the light emission of the plurality of subfields forms two or more peaks, the correction portion correct the rearranged light emission data generated by the regeneration portion such that light is emitted in a non-emission subfield with a shortest emission period for each of the peaks.

In this case, although light emission in the non-emission subfield with the shortest emission period is not originally necessary, because the emission period of this subfield is shortest, even when light is emitted at each peak in this subfield, emission in this subfield is not perceived by a viewer, and motion blur and dynamic false contours can be suppressed reliably; in addition, in a driving method in which the brightness distribution forms two or more peaks, light can be reliably emitted in the subfield for which the immediately preceding non-emission period is longest.

It is preferable that the correction portion change at least one subfield, among the plurality of subfields, set at a most temporally advanced position, from a non-emission subfield to an emission subfield.

In this case, at least one subfield arranged in the temporally most advanced position is changed from a non-emission subfield to an emission subfield, so that even when light is emitted in this subfield, the emission in this subfield is not perceived by a viewer, and motion blur and dynamic false contours can be suppressed reliably.

It is preferable that among the plurality of subfields, a subfield with a longest emission period be set at a temporally final position, and that the correction portion do not correct rearranged light emission data for the subfield set at the temporally final position among the plurality of subfields.

In this case, the subfield with the longest emission period is arranged at the temporally final position; if light were caused to be emitted unnecessarily in this subfield, a viewer would perceive the unnecessary emission in this subfield, and it would be difficult to suppress motion blur and dynamic false contours. But the rearranged light emission data for this subfield is not corrected, and so a viewer does not perceive unnecessary emission in this subfield, and motion blur and dynamic false contours can be reliably suppressed.

It is preferable that the correction portion measure a time of use of the apparatus, and correct the rearranged light emission data generated by the regeneration portion after a certain time of use has elapsed.

In this case, because the ease of light emission in each subfield declines with the time of use of the apparatus, before the certain time of use has elapsed, rearranged light emission data is used without modification and light emission is caused only in the necessary subfields, while suppressing motion blur and dynamic false contours; after the certain time of use has elapsed, the rearranged light emission data can be corrected, and while causing light emission in the necessary subfields, motion blur and dynamic false contours can be reliably suppressed.

A video display apparatus of this invention includes: any of the above-described video processing apparatuses; and a display portion which displays video using corrected rearranged light emission data output from the video processing apparatus.

In this video display apparatus, after light is emitted in one non-emission subfield in advance of the emission subfield for which the immediately preceding non-emission period is longest, light is emitted in the emission subfield for which the immediately preceding non-emission period is longest, and the non-emission period between subfields in which light is emitted can be shortened, so that light emission can be caused more reliably in subfields in which light is to be emitted, and motion blur and dynamic false contours can be suppressed more reliably.

### INDUSTRIAL APPLICABILITY

A video processing apparatus of this invention can reliably cause light emission in subfields in which light is to be emitted, and can more reliably suppress motion blur and dynamic false contours, and so is useful as a video processing apparatus which performs processing of input images to divide one field or one frame into a plurality of subfields, and combines emission subfields in which light is emitted and non-emission subfields in which light is not emitted to perform gradation display.

1. A video processing apparatus, which processes an input image so as to divide one field or one frame into a plurality of subfields and combine an emission subfield in which light is emitted and a non-emission subfield in which light is not emitted in order to perform gradation display, the video processing apparatus comprising:
a subfield conversion portion which converts the input image into light emission data for each of the subfields;
a motion vector detection portion which detects a motion vector using at least two or more input images before and after in time;
a regeneration portion which generates rearranged light emission data for each of the subfields by spatially rearranging the light emission data for each of the subfields converted by the subfield conversion portion according to the motion vector detected by the motion vector detection portion; and
a correction portion which corrects the rearranged light emission data generated by the regeneration portion such that, among the plurality of subfields, light is emitted in at least one non-emission subfield temporally in advance of at least one emission subfield for which an immediately preceding non-emission period is longest.

2. The video processing apparatus according to claim 1, wherein the correction portion performs correction of the rearranged light emission data generated by the regeneration portion such that, among the plurality of subfields, light is emitted in a non-emission subfield with a shortest emission period.

3. The video processing apparatus according to claim 2, wherein, when a brightness distribution formed by all light emission of the plurality of subfields forms two or more peaks, the correction portion corrects the rearranged light emission data generated by the regeneration portion such that light is emitted in a non-emission subfield with a shortest emission period for each of the peaks.

4. The video processing apparatus according to claim 2, wherein, among the plurality of subfields, a subfield with the shortest emission period is set at a most temporally advanced position, and
the correction portion changes at least one subfield set at the most temporally advanced position among the plurality of subfields from a non-emission subfield to an emission subfield.

5. The video processing apparatus according to claim 1, wherein, among the plurality of subfields, a subfield with a longest emission period is set at a temporally final position, and
the correction portion does not correct rearranged light emission data for the subfield set at the temporally final position among the plurality of subfields.

6. The video processing apparatus according to claim 1, wherein the correction portion measures a time of use of the apparatus, and corrects the rearranged light emission data generated by the regeneration portion after a certain time of use has elapsed.

7. A video display apparatus, comprising:
the video processing apparatus according to claim 1; and
a display portion which displays video using corrected rearranged light emission data output from the video processing apparatus.
